(19) United States
(12) Patent Application Publication
(10) Pub. No.: US 2023/0327116 A1
(43) Pub. Date: Oct. 12, 2023

(54) GROUP 15 METAL HALIDE SALT ELECTRODES

(71) Applicant: THE UNIVERSITY COURT OF THE UNIVERSITY OF EDINBURGH, Edinburgh (GB)

(72) Inventors: Neil ROBERTSON, Edinburgh (GB); Tianyue LI, Edinburgh (GB); Kingshuk ROY, Edinburgh (GB); Satishchandra OGALE, Edinburgh (GB)

(21) Appl. No.: 17/928,591

(22) PCT Filed: May 28, 2021
(86) PCT No.: PCT/GB2021/051312

§ 371 Date: Nov. 29, 2022

(30) Foreign Application Priority Data
Jun. 2, 2020 (GB) 2008274.9

(51) Int. Cl. H01M 10/054; H01M 4/13; H01M 10/0525; H01M 4/62; H01M 4/60; H01M 4/66; C07F 9/94

(52) U.S. Cl. CPC H01M 4/60; C07F 9/94; H01M 4/13; H01M 4/623; H01M 4/625; H01M 4/661; H01M 10/0525; H01M 10/054

(57) ABSTRACT

This invention relates to an electrode comprising (a) as an anion, a halide of either bismuth or antimony, wherein the halide is bromide or iodide, and (b) a cation. The invention also relates to a sodium ion or lithium ion battery comprising the electrode, and a laptop, mobile phone, electric vehicle or grid storage system comprising the sodium ion or lithium ion battery. In addition, the invention relates to a method of making the electrode comprising the steps of: (a) preparing a first solution comprising a halide of either bismuth or antimony, wherein the halide is bromide or iodide, (b) preparing a second solution comprising a cation, (c) mixing the first and second solutions, and (d) drying the resulting product.

This invention relates to electrodes comprising a halide of a Group 15 metal or metalloid, and a cation, as well as to batteries comprising these electrodes.

### BACKGROUND

Due to ever increasing demand for robust, durable and cost effective stationary (grid) and transportable (laptops, mobile phones, vehicles etc.) electrical energy storage, copious work has been done in the development of such energy storage devices. Among these Li-ion batteries have achieved the best performance so far, with high stability, high energy density and low cost¹⁻⁵. In addition, some more recent technologies in the energy storage field, such as Na-ion, Li-air, Na-air, Zn-air, Li—S etc. have also started to show growing promise⁶⁻¹⁹. These however, have yet to match the performance of Li-ion batteries and, in the current scenario, enormous studies are still essential in the field of Li-ion batteries to further increase stability, power and energy density, safety etc.

Although carbon-based materials are the leading option for the anode electrode in terms of cyclic stability and cost effectiveness, substantial research effort is going into developing different kinds of conversion, alloying and alloying-cum-conversion anodes due to the theoretical capacity limit (372 mAhg⁻¹) for graphitic carbons²⁰⁻³⁰. Although alloying materials like Si, Sn, Ge, P etc. are of great interest due to their extremely high theoretical capacity (4200 mAhg⁻¹ for Si, 992 mAhg⁻¹ for Sn), they suffer from the inherent problem of huge volume expansion during lithiation and de-lithiation which limits their long-term stability and commercial use²⁵, ³¹⁻³⁴. Many conversion and alloying-cum-conversion materials also suffer from the same issue. Hence, the utmost need to design an anode material capable of rendering a significantly higher capacity along with other merits including impressive stability, facile preparation and low cost.

Recently, Zhong et. Al³⁵ has studied Bi nanoparticle anchored N-doped porous carbon as anode for Li-ion batteries and achieved a reversible capacity of 300 mAhg⁻¹ at a current density of 155 mAg⁻¹. Also, Park et. al.³⁶ reported a Bi@C composite which showed a reversible capacity of 300 mAhg⁻¹ after 100 cycles at 100 mAg⁻¹ and Yang et. al.³⁷ reported Bi@C microspheres which showed a reversible capacity of 280 mAhg⁻¹ after 100 cycles at 100 mAg⁻¹. In addition, there are several reports on the oxides and sulphides of Bismuth, however these also suffer the challenge of substantial volume expansion leading to poor stability³⁸⁻⁴².

Hybrid lead-halide perovskites have emerged as the new generation of electronic materials for photovoltaic applications, optoelectronic devices, and energy storage devices. However, the intrinsic structural instability and adverse effects associated with the toxic element lead may limit practical application. Improved anode materials for use in lithium-ion batteries have therefore been sought.

### Statement of Invention

This invention relates to an electrode comprising (a) as an anion, a halide of either bismuth or antimony, wherein the halide is bromide or iodide, and a cation.

In particular, the electrode may comprise, as an anion, a halide of bismuth. In particular, the halide may be iodide. More particularly, electrode may comprise, as an anion, an iodide of bismuth.

More particularly, the cation may be an organic cation, even more particularly a heterocyclic cation. In particular, the heterocyclic cation may be an azolium ion.

In particular, the azolium ion may be an imidazolium, thiadiazolium or thiazolium ion. More particularly, the thiadizolium ion may be an amino thiadiazolium ion. In particular, the thiazolium ion may be an amino thiazolium ion.

Even more particularly, the electrode may comprise [C₃H₅N₂]₃[Bi₂I₉], [C₂H₄N₃S][BiI₄] or [C₃H₅N₂S][BiI₄].

More particularly, the electrode may additionally comprise carbon and/or a binder. In some embodiments, the carbon may be super-p carbon. In some embodiments, the binder may be polyvinylidene difluoride.

In particular, the halide of bismuth or antimony, and cation, and optional carbon and/or binder, may be coated onto a copper foil.

This invention also relates to a sodium ion or lithium ion battery, more particularly a lithium ion battery, comprising an electrode as defined above. More particularly, the electrode may be the anode. In particular, the sodium ion or lithium ion battery may additionally comprise an electrolyte. More particularly, when the battery is a lithium ion battery, the electrolyte may comprise a lithium salt dissolved in an organic carbonate. Even more particularly, the lithium salt may comprise LiPF₆. More particularly, the organic carbonate may comprise ethylene carbonate and/or dimethyl carbonate.

This invention also relates to a laptop, mobile phone, electric vehicle or grid storage system comprising a sodium ion or lithium ion battery as defined above, more particularly a lithium ion battery.

In addition, this invention relates to a method of making an electrode as defined above, the method comprising the steps of:
(a) preparing a first solution comprising a halide of either bismuth or antimony, wherein the halide is bromide or iodide,
(b) preparing a second solution comprising a cation,
(c) mixing the first and second solutions, and
(d) drying the resulting product.

In particular, the first solution may comprise bismuth. In particular, in the first solution the halide may be iodide. More particularly, the first solution may comprise bismuth iodide.

More particularly, in the second solution the cation may be an organic cation, even more particularly a heterocyclic cation. In particular, in the second solution the heterocyclic cation may be an azolium ion. In particular, in the second solution the azolium ion may be an imidazolium, thiadiazolium or thiazolium ion. More particularly, in the second solution the thiadiazolium ion may be an amino thiadiazolium ion. In particular, in the second solution the thiazolium ion may be an amino thiazolium ion.

In particular, the method may additionally comprise, after step (d), the step of:
(e) mixing the product with carbon and/or a binder.

In some embodiments the carbon may be super-p carbon. In some embodiments, the binder may be polyvinylidene difluoride.

In particular, the method may additionally comprise, after step (e), the step of:
(f) coating the mixture formed in step (e) onto a copper foil.

In addition, this disclosure relates to a composition comprising bismuth iodide and an azolium ion. In particular, the azolium ion may be an imidazolium, thiadiazolium or thiazolium ion. More particularly, the thiadiazolium ion may be an amino thiadiazolium ion. In particular, the thiazolium ion may be an amino thiazolium ion. More particularly, the composition may comprise [C₃H₅N₂]₃[Bi₂I₉], [C₂H₄N₃S][BiI₄] or [C₃H₅N₂S][BiI₄].

In particular, the composition may additionally comprise carbon and/or a binder. More particularly, the carbon may be super-p carbon. In particular, the binder may be polyvinylidene difluoride.

### BRIEF DESCRIPTION OF THE DRAWINGS

This invention will be further described by reference to the following Figures which are not intended to limit the scope of the invention claimed, in which:

FIG. 1 shows schematic diagrams of crystal structures for ATB (a), ADB (b) and IMB (c). The unit cell boundary is marked with dark lines. Hydrogen atoms are omitted for clarity.

FIG. 2 shows the electrochemical performance of an IMB anode in a coin cell with Li counter electrode (a) constant current discharge (b) cyclic voltammetry (c) rate performance and (d) cycle stability.

FIG. 3 shows the electrochemical performance of an ADB anode in a coin cell with Li counter electrode (a) constant current discharge (b) cyclic voltammetry (c) rate performance and (d) cycle stability.

FIG. 4 shows the electrochemical performance of ATB anode in a coin cell with Li counter electrode (a) constant current discharge (b) cyclic voltammetry (c) rate performance and (d) cycle stability.

### EXPERIMENTAL

Herein, for the very first time we report Group 15 halide salt based materials for use as high-capacity and highly-stable electrodes, in particular for anode materials for Li ion batteries. Three different Bi based materials [C₃H₅N₂]₃[Bi₂I₉] (IMB), [C₂H₄N₃S][BiI₄] (ADB) and [C₃H₅N₂S][BiI₄] (ATB) were studied. Alongside high capacity and stability it can be further noted that Bi is non-toxic material unlike the widely used Pb halide materials, which will avoid limitations associated with safety in manufacturing, operation or disposal. Among the three hybrid materials used, IMB and ADB showed exceptional promise in terms of capacity values, although all the materials showed good lithiation de-lithiation stability. ADB and IMB and ATB showed a reversible capacity of 520 mAhg⁻¹ and 450 mAhg⁻¹ and 230 mAhg⁻¹ respectively after 250 charging and discharging cycles. Furthermore, the materials have proven favourable in terms of power density by a very good rate performance when exposed to a variable current density.

Our study provides a preliminary and promising insight into low-cost and non-toxic Group 15 halide, particularly iodobismuthate, materials, and thereby establishes them as a new, tunable materials family for electrodes, particularly as anode materials for lithium-ion batteries.

### Synthesis of IMB, ADB and ATB Powder

For ATB and ADB, a 1:1 molar ratio of aminothiazolium iodide (or 2-amino-1, 3, 4-thiadiazolium for ADB) and bismuth iodide were dissolved separately in water (room temperature) and ethanol (60° C.) before mixing. The reaction was left for 3 hours before drying by a rotary evaporator. For IMB, a 3:2 molar ratio of imidazolium iodide and bismuth iodide was reacted with the same method above. The as-prepared powders were washed in diethyl ether followed by drying under vacuum.

### Electrode Fabrication

Electrodes were fabricated by direct mixing of the active materials (Bi based materials), Super-P carbon and Polyvinylidene difluoride (PVDF) binder in N-methyl 2-pyrollidine (NMP) solvent followed by coating the mixture onto a conducting Cu foil. It was then dried overnight in an oven at 80° C.

### Coin Cell Fabrication

2032 coin cells were fabricated using Li metal as one of the electrodes alongside celgard separators. Lithium hexafluorophosphate (LiPF₆) was dissolved in a 1:1 mixture of Ethylene Carbonate (EC) and Di-methyl Carbonate (DMC) with a 5% Fluoroethylene Carbonate (FEC) additive used as the electrolyte.

### Electrochemical Characterizations

Cyclic voltammetry was performed using an Ametek potentiostat at a scan-rate of 0.1 mV/s with vertex potentials of 0.01 and 3 V. The galvanostatic charge discharge measurements were carried out with MTI corporation battery analyzer at variable current densities from 0.05 Ag⁻¹ to 2 Ag⁻¹. The electrochemical impedance spectroscopy (EIS) measurements were studied using the Ametek potentiostat instrument within a frequency range of 300 KHz to 100 mHz.

### Material Preparations and Crystal Structures

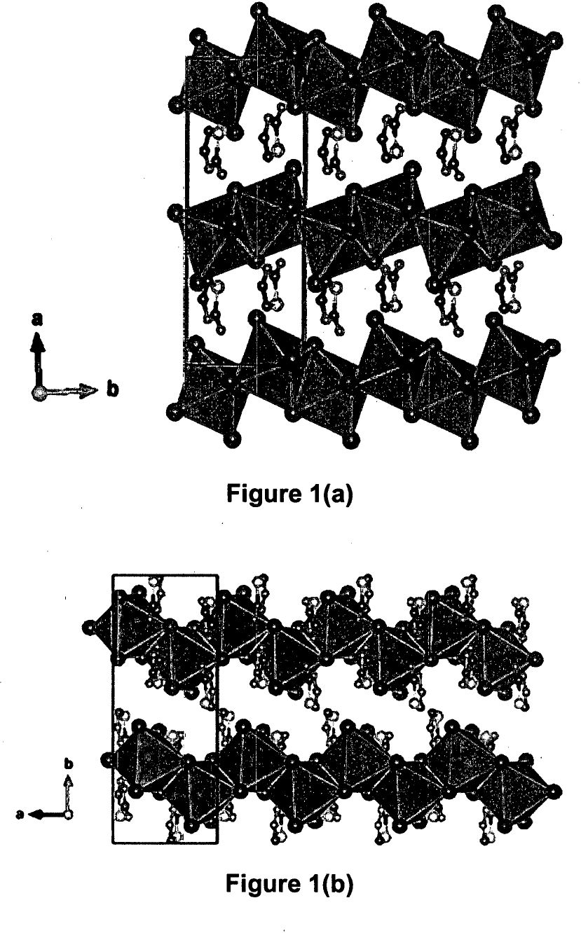

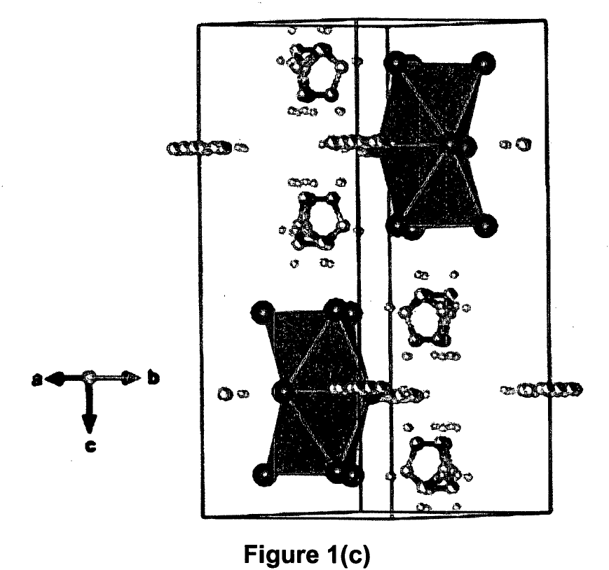

Schematic crystal structure diagrams of IMB, ADB and ATB are shown in FIG. 1. One-dimensional edge-sharing chains built by [BiI₆]³⁻ octahedra can be found in both ATB and ADB, with organic counter-ions in between the chains. For IMB, zero-dimensional binuclear [Bi₂I₉]³⁻ clusters construct the inorganic framework of the crystal structure, with highly disordered imidazolium as counter-ions. We aimed to exploit the inorganic skeleton of bismuth-iodides with lower dimensionality to better enable lithium ion insertion structurally, especially via the one-dimensional Bi—I chains in ADB and ATB, and the zero-dimensional Bi—I binuclear octahedra in IMB. Fine powders of each material were prepared via fast precipitation directly from an solution of bismuth iodide with an aqueous solution of counter-ion iodide salt. The powder diffraction patterns (PXRD) of the materials showed a good match between the experimental PXRD peaks and those predicted from the published single-crystal structures. No indication of starting materials was shown in the diffraction patterns, indicating good product and phase purity.

### Electrochemical Studies of IMB, ADB and ATB

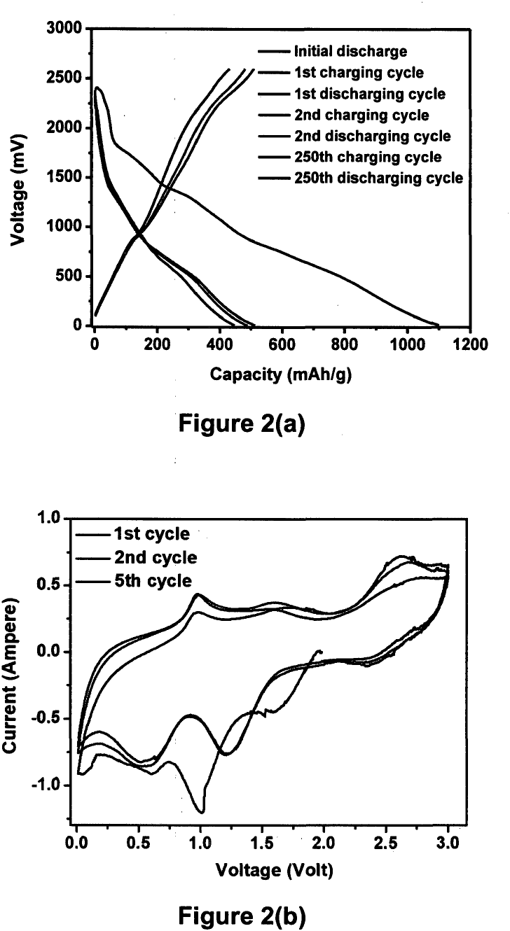

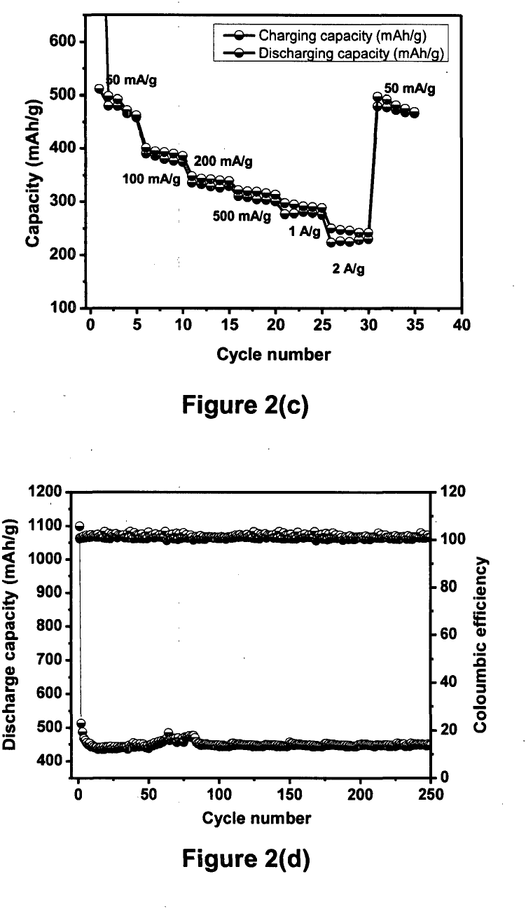

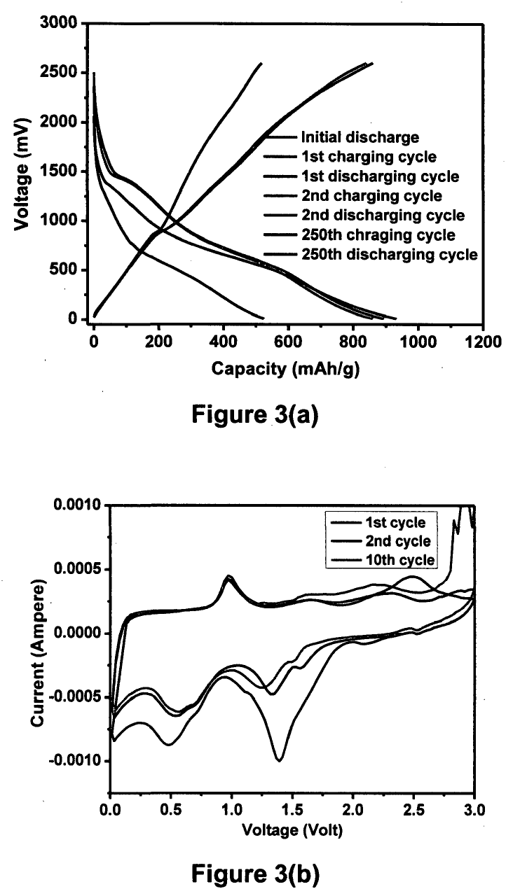

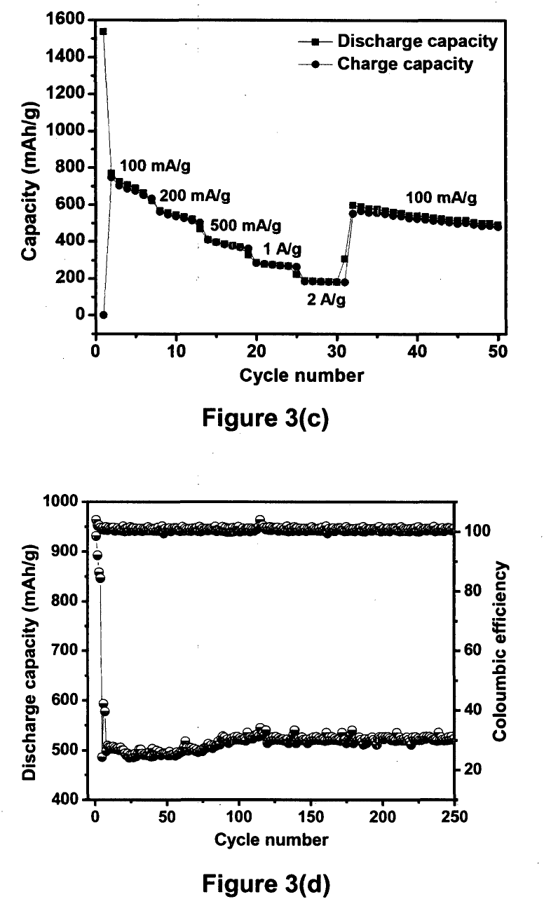

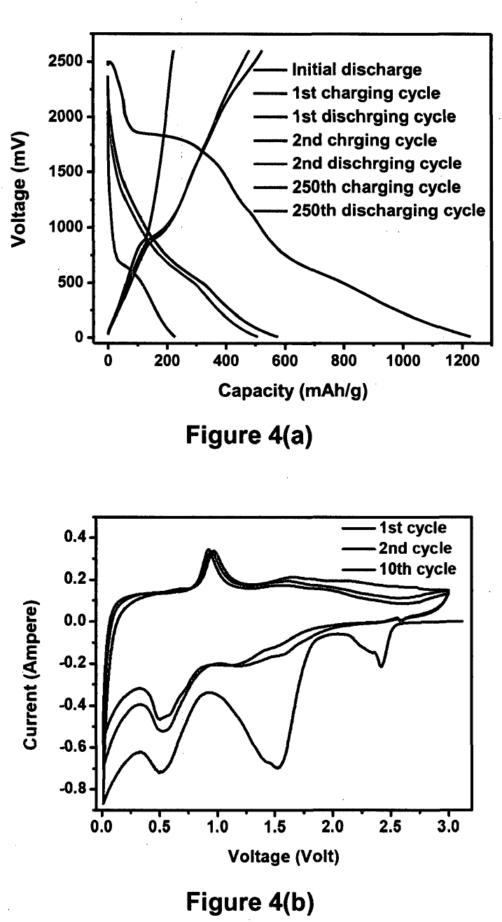

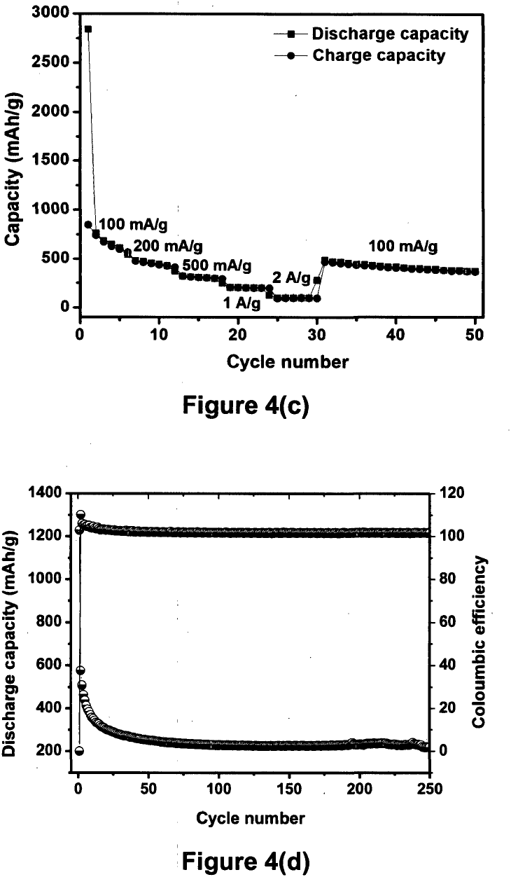

Li-ion storage properties were measured for IMB, ADB and ATB. Coin cells with a lithium metal counter electrode were prepared using established methods. Constant current charge discharge data showed an initial discharge capacity of 1100 mAhg⁻¹, 930 mAhg⁻¹, and 1220 mAhg⁻¹, for IMB, ADB and ATB respectively, and subsequently reversible Li-ion capacity of 450 mAhg⁻¹, 520 mAhg⁻¹, and 230 mAhg⁻¹ (FIGS. 2a, 3a, 4a respectively) after 250 charge discharge cycle at an applied current density of 100 mAg⁻¹. Cyclic voltammetry measurements were also carried out to probe the mechanism of lithiation and de-lithiation, and in all three cases a reversible lithiation peak was found at ~0.6 Volt which signifies the formation of Li₃Bi (FIGS. 2b, 3b, 4b). Also, in all the three cases, a reversible de-lithiation peak was found at ~1 Volt. A signature of reversible Li uptake can also be seen in the charge discharge curves (FIGS. 2a, 3a, 4a). The lithiation voltage from charge discharge plots and from the cyclic voltammetry plots are clearly correlated.

Impressive rate performances were shown by IMB, ADB and ATB where exposed to current densities of 50 mAg⁻¹, 100 mAg⁻¹, 200 mAg⁻¹, 500 mAg⁻¹, 1 Ag⁻¹ and 2 Ag⁻¹. Reversible capacities of 250 mAhg⁻¹, 200 mAhg⁻¹ and 110 mAhg⁻¹ were shown by IMB, ADB and ATB respectively (FIGS. 2c, 3c, 4c) when high current density of 2 Ag⁻¹ was employed. In all cases, the material showed excellent stability, with 100% retention of the reversible capacity after 250 charge discharge cycles (FIGS. 2d, 3d, 4d).

The exceptionally high capacity of IMB and ADB is surprising, since formation of the Li₃Bi alloy from these materials can only lead to a theoretical capacity of 197, 196 and 182 mAhg⁻¹ respectively, according to equations 1 and 2. This limitation arises due to the high atomic masses of both bismuth and iodine. We note however, that for ADB and IMB, one extra lithiation peak is observed around 1.25 - 1.4 V, which is absent in the case of ATB. This process apparently provides the higher capacity of ADB and IMB compared with ATB.

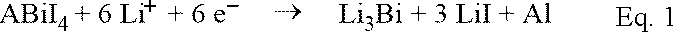

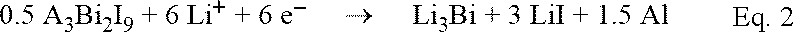

### Conclusions

This work shown, for the first time, Group 15 halides, in particular Bi based organic-inorganic hybrid materials, as candidates for reversible Li ion uptake and release when used as anode materials for Li-ion batteries. The systems not only showed a high Li ion storage property but also delivered an impressive power density when exposed to variable current density, and showed excellent stability over 250 cycles. The materials are environmentally friendly as a non-toxic material, Bi, was used. It is believed that this work is highly novel and has the ability to open up a potentially-limitless series of new compounds to be used as anodes for Li-ion batteries since the counter-ion can be tuned across a range of many other organic, and possibly inorganic, cations.

### REFERENCES

1 M. Li, J. Lu, Z. Chen and K. Amine, Adv. Mater., 2018, 30, 1-24.

2 V. Etacheri, R. Marom, R. Elazari, G. Salitra and D. Aurbach, Energy Environ. Sci., 2011, 4, 3243-3262.

3 J. B. Goodenough and K. S. Park, J. Am. Chem. Soc., 2013, 135, 1167-1176.

4 J. Lu, Z. Chen, F. Pan, Y. Cui and K. Amine, Electrochem. Energy Rev., 2018, 1, 35-53.

5 P. Roy and S. K. Srivastava, J. Mater. Chem. A, 2015, 3, 2454-2484.

6 L. Li, Y. Zheng, S. Zhang, J. Yang, Z. Shao and Z. Guo, Energy Environ. Sci., 2018, 11, 2310-2340.

7 N. Yabuuchi, K. Kubota, M. Dahbi and S. Komaba, Chem. Rev., 2014, 114, 11636-11682.

8 N. Imanishi and O. Yamamoto, Mater. Today Adv., 2019, 4, 100031.

9 N. Chawla and M. Safa, Electron.,, DOI:10.3390/electronics8101201.

10 V. Palomares, P. Serras, I. Villaluenga, K. B. Hueso, J. Carretero-Gonzalez and T. Rojo, Energy Environ. Sci., 2012, 5, 5884-5901.

11 R. Kumar, J. Liu, J. Y. Hwang and Y. K. Sun, J. Mater. Chem. A, 2018, 6, 11582-11605.

12 J. Christensen, P. Albertus, R. S. Sanchez-Carrera, T. Lohmann, B. Kozinsky, R. Liedtke, J. Ahmed and A. Kojic, J. Electrochem. Soc., 2012, 159.

13 K. N. Jung, J. Kim, Y. Yamauchi, M. S. Park, J. W. Lee and J. H. Kim, J. Mater. Chem. A, 2016, 4, 14050-14068.

14 X. Xu, K. S. Hui, D. A. Dinh, K. N. Hui and H. Wang, Mater. Horizons, 2019, 1306-1335.

15 S. K. Das, S. Lau and L. A. Archer, J. Mater. Chem. A, 2014, 2, 12623-12629.

16 J. Fu, R. Liang, G. Liu, A. Yu, Z. Bai, L. Yang and Z. Chen, Adv. Mater., 2018, 1805230, 1-13.

17 Y. Li and H. Dai, Chem. Soc. Rev., 2014, 43, 5257-5275.

18 M. Barghamadi, A. Kapoor and C. Wen, J. Electrochem. Soc., 2013, 160, A1256-A1263.

19 A. Manthiram, Y. Fu, S. H. Chung, C. Zu and Y. S. Su, Chem. Rev., 2014, 114, 11751-11787.

20 K. Cao, T. Jin, L. Yang and L. Jiao, Mater. Chem. Front., 2017, 1, 2213-2242.

21 Y. Lu, L. Yu and X. W. (David) Lou, Chem, 2018, 4, 972-996.

22 H. H. Fan, H. H. Li, K. C. Huang, C. Y. Fan, X. Y. Zhang, X. L. Wu and J. P. Zhang, ACS Appl. Mater. Interfaces, 2017, 9, 10708-10716.

23 M. N. Obrovac and V. L. Chevrier, Chem. Rev., 2014, 114, 11444-11502.

24 W. J. Zhang, J. Power Sources, 2011, 196, 13-24.

25 K. Roy, M. Wahid, D. Puthusseri, A. Patrike, S. Muduli, R. Vaidhyanathan and S. Ogale, Sustain. Energy Fuels, 2019, 3, 245-250.

26 F. Kong, L. Lv, Y. Gu, S. Tao, X. Jiang, B. Qian and L. Gao, J. Mater. Sci., 2019, 54, 4225-4235.

27 X. Ma, L. Zou and W. Zhao, Chem. Commun., 2018, 54, 10507-10510.

28 J. M. Yan, H. Z. Huang, J. Zhang, Z. J. Liu and Y. Yang, J. Power Sources, 2005, 146, 264-269.

29 Y. P. Wu, E. Rahm and R. Holze, J. Power Sources, 2003, 114, 228-236.

30 L. S. Roselin, R. Juang, C. Hsieh, S. Sagadevan, A. Umar, R. Selvin and H. H. Hegazy, Materials (Basel)., 2019, 12, 1229.

31 M. Ashuri, Q. He and L. L. Shaw, Nanoscale, 2016, 8, 74-103.

32 P. Li, G. Zhao, X. Zheng, X. Xu, C. Yao, W. Sun and S. X. Dou, Energy Storage Mater., 2018, 15, 422-446.

33 M. G. Park, D. H. Lee, H. Jung, J. H. Choi and C. M. Park, ACS Nano, 2018, 12, 2955-2967.

34 H. Ying and W. Q. Han, Adv. Sci., 2017, 4.

35 Y. Zhong, B. Li, S. Li, S. Xu, Z. Pan, Q. Huang, L. Xing, C. Wang, W. Li and C. Wang, Nano-Micro Lett., 2018, 10, 1-14.

36 C. M. Park, S. Yoon, S. II Lee and H. J. Sohn, J. Power Sources, 2009, 186, 206-210.

37 F. Yang, F. Yu, Z. Zhang, K. Zhang, Y. Lai and J. Li, Chem. - A Eur. J., 2016, 22, 2333-2338.

38 Y. Dong, M. Hu, Z. Zhang, J. A. Zapien, X. Wang and J. M. Lee, Nanoscale, 2018, 10, 13343-13350.

39 W. Chai, F. Yang, W. Yin, S. You, K. Wang, W. Ye, Y. Rui and B. Tang, Dalt. Trans., 2019, 48, 1906-1914.

40 Z. Deng, T. Liu, T. Chen, J. Jiang, W. Yang, J. Guo, J. Zhao, H. Wang and L. Gao, ACS Appl. Mater. Interfaces, 2017, 9, 12469-12477.

41 Y. Li, M. A. Trujillo, E. Fu, B. Patterson, L. Fei, Y. Xu, S. Deng, S. Smirnov and H. Luo, J. Mater. Chem. A, 2013, 1, 12123-12127.

42 S. Liu, Z. Cai, J. Zhou, A. Pan and S. Liang, J. Alloys Compd., 2017, 715, 432-437.

43 N. Vicente and G. Garcia-Belmonte, J. Phys. Chem. Lett., 2017, 8, 1371-1374.

44 H. R. Xia, W. T. Sun and L. M. Peng, Chem. Commun., 2015, 51, 13787-13790.

45 M. Tathavadekar, S. Krishnamurthy, A. Banerjee, S. Nagane, Y. Gawli, A. Suryawanshi, S. Bhat, D. Puthusseri, A. D. Mohite and S. Ogale, J. Mater. Chem. A, 2017, 5, 18634-18642.

46 Q. Wang, T. Yang, H. Wang, J. Zhang, X. Guo, Z. Yang, S. Lu and W. Qin, CrystEngComm, 2019, 21, 1048-1059.

47 A. Kostopoulou, D. Vernardou, K. Savva and E. Stratakis, Nanoscale, 2019, 11, 882-889.

48 W. Zhang, G. E. Eperon and H. J. Snaith, Nat. Energy,, DOI:10.1038/nenergy.2016.48.

49 H. R. Xia, W. T. Sun and L. M. Peng, Chem. Commun., 2015, 51, 13787-13790.

50 N. Vicente and G. Garcia-Belmonte, J. Phys. Chem. Lett., 2017, 8, 1371-1374.

51 R. A. Wheeler and P. N. V. P. Kumar, J. Am. Chem. Soc., 1992, 114, 4776-4784.

52 L. Zhang, K. Wang and B. Zou, ChemSusChem, 2019, 12, 1612-1630.

53 N. C. Miller and M. Bernechea, APL Mater.,, DOI:10.1063/1.5026541.

54 Z. Qi, X. Fu, T. Yang, D. Li, P. Fan, H. Li, F. Jiang, L. Li, Z. Luo, X. Zhuang and A. Pan, Nano Res., 2019, 12, 1894-1899.

55 K. Adams, A. F. González, J. Mallows, T. Li, J. H. J. Thijssen and N. Robertson, J. Mater. Chem. A, 2019, 7, 1638-1646.

56 T. Li, J. Mallows, K. Adams, G. S. Nichol, J. H. J. Thijssen and N. Robertson, Batter. Supercaps,, DOI:10.1002/batt.201900005.

57 T. Li, Q. Wang, G. S. Nichol, C. A. Morrison, H. Han, Y. Hu and N. Robertson, Dalt. Trans., 2018, 47, 7050-7058.

58 V. G. Campi, J. Chem. Crystallogr., 1994, 24, 3-6.

1. An electrode comprising (a) as an anion, a halide of either bismuth or antimony, wherein the halide is bromide or iodide, and (b) a cation.

2. The electrode of claim 1 wherein the cation is a heterocyclic cation.

3. The electrode of in claim 2, wherein the heterocyclic cation is an azolium ion.

4. The electrode of claim 1, comprising [C₃H₃N₂]₃[Bi₂I₉], [C₂H₄N₃S][BiI₄] or [C₃H₃N₂S][BiI₄].

5. The electrode of claim 1, additionally comprising carbon and/or a binder.

6. The electrode of claim 1, wherein the halide of bismuth or antimony, and cation, and optional carbon and/or binder, are coated onto a copper foil.

7. A sodium ion or lithium ion battery comprising the electrode of claim 1 .

8. A laptop, mobile phone, electric vehicle or grid storage system comprising the sodium ion or lithium ion battery of claim 7.

9. A method of making the electrode of claim 1 the method comprising the steps of:
(a) preparing a first solution comprising a halide of either bismuth or antimony, wherein the halide is bromide or iodide,
(b) preparing a second solution comprising a cation,
(c) mixing the first and second solutions, and
(d) drying the resulting product.

10. The method of claim 9, wherein in the second solution the cation is a heterocyclic cation.

11. The A method of claim 10, wherein the heterocyclic cation is an azolium ion.

12. The A method of claim 9, wherein the method additionally comprises, after step (d), the step of:
(e) mixing the product with carbon and/or a binder.

13. The A method of claim 12, wherein the method additionally comprises, after step (e), the step of:
(f) coating the mixture formed in step (e) onto a copper foil.
